(19) United States
(12) Patent Application Publication
(10) Pub. No.: US 2006/0122750 A1
(43) Pub. Date: Jun. 8, 2006

(54) Telematics equipment having preference extraction function

(76) Inventors: Yeon Jun Choi, Daejeon (KR); Min Jung Kim, Daejeon (KR); Moon Soo Lee, Daejeon (KR); Oh Cheon Kwon, Daejeon (KR); Jong Woo Choi, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/292,706

(22) Filed: Dec. 1, 2005

(30) Foreign Application Priority Data
Dec. 7, 2004 (KR) 2004-102478
Sep. 27, 2005 (KR) 2005-89707

(51) Int. Cl. G06F 17/00

(52) U.S. Cl. 701/36; 701/1

(57) ABSTRACT

Provided is telematics equipment connected to various devices of a vehicle, and configured to receive information from the exterior through a network, the telematics equipment including: a certification module for receiving personal information from a driver of the vehicle to provide use authority; a collecting module for collecting propensity and pattern information when the driver uses the various devices of the vehicle; a database for storing the collected propensity and pattern information; a personalization module for analyzing the collected propensity and pattern information and extracting preference information of the driver; and a processing module for receiving the preference information from the personalization module and generating signals for controlling the various devices, whereby it is possible to extract the preference of the driver through the personalization to set the various devices of the vehicle to the driver in an optimal state.

### CROSS-REFERENCE TO RELATED APPLICATION

This application claims priority to and the benefit of Korean Patent Application Nos. 2004-102478, filed on Dec. 7, 2004, and 2005-89707, filed on Sep. 27, 2005, the disclosure of which is incorporated herein by reference in its entirety.

### BACKGROUND

1. Field of the Invention

The present invention relates to telematics equipment installed in a vehicle, and more particularly, to telematics equipment having a function for extracting preference of a driver through personalization to set various devices of the vehicle to an optimal state.

2. Discussion of Related Art

Recently, as various interface technologies, wire or wireless communication technologies, and internet-based technologies have been developed, various telematics equipment for providing safety and convenience to drivers have been installed in vehicles.

The telematics equipment is driven by predetermined software to allow a driver or passenger to easily use various electronic control devices such as a speedometer, a wiper, and so on, a global positioning system (GPS) receiver, input/output devices such as a display, a keyboard, a mouse, a microphone and so on, communication devices such as a mobile phone, Bluetooth devices, a wireless local area network (WLAN), wireless broadband (WiBro) and so on, and broadcasting equipment such as an audio device, digital multimedia broadcasting (DMB) and so on, and to receive various information from the exterior through a wireless or mobile communication network.

Nowadays, in order to provide optimal convenience to drivers, research into personalization is applied to the telematics equipment. System personalization using Java language is researched by Sun Microsystems Inc., and research for reflecting personal preference is performed by European Telematics Implementation Coordination Organization (ERTICO) and so on.

Meanwhile, Korean Patent Laid-open publication No. 2003-51729, filed on Jun. 25, 2003, discloses technology of receiving compressed digital content through a wireless LAN from a computer system on the basis of user preference input in the computer system, and reproducing the digital content through an output device of a vehicle.

In addition, Korean Patent Laid-open Publication No. 2003-64765, filed on Aug. 2, 2003, discloses technology of collecting data about operating states of interior and exterior parts of a vehicle, and providing a priority order to the vehicle information on the basis of cognitive load of an operator to selectively inform the information to the operator.

However, mining technology about predetermined pattern information of a user and research on preference analysis using the same are not yet performed.

### SUMMARY OF THE INVENTION

The present invention is directed to telematics equipment having a preference extraction function capable of providing safety and optimal convenience to a driver by collecting propensity and pattern information when drivers use various devices and information of a vehicle, and extracting preference on the basis of the collected information to apply the preference to the various devices.

One aspect of the present invention provides telematics equipment connected to various devices of a vehicle, and configured to receive information from the exterior through a network, the telematics equipment including: a certification module for receiving personal information from a driver of the vehicle to provide use authority; a collecting module for collecting propensity and pattern information when the driver uses the various devices of the vehicle; a database for storing the collected propensity and pattern information; a personalization module for analyzing the collected propensity and pattern information and extracting preference information of the driver; and a processing module for receiving the preference information from the personalization module and generating signals for controlling the various devices.

The various devices may include an electronic control device and a personal handheld terminal, which are installed in the vehicle.

The preference information may be information for determining a preference action of the driver, and the pattern information may be information for analyzing the preference action according to time.

The personalization module may extract the preference information periodically and non-periodically according to a predetermined rule, or may extract the preference information when the telematics equipment is initially operated, and the rule may be algorithm according to at least one of the number of uses, priority order, and probability.

The present invention provides the telematics equipment capable of providing safety and optimal convenience to the driver. The telematics equipment collects the propensity and pattern information when the driver uses various devices and information of a vehicle, and extracts the preference information on the basis of the collected information. According to the preference information, control signals are generated in order to set the various devices of the vehicle in an optimal state.

### BRIEF DESCRIPTION OF THE DRAWINGS

The above and other features of the present invention will be described in reference to certain exemplary embodiments thereof with reference to the attached drawings in which:

FIG. 1 is a block diagram of telematics equipment having a preference extraction function in accordance with the present invention; and

FIG. 2 is a flow chart showing operations of telematics equipment having a preference extraction function in accordance with the present invention.

### DETAILED DESCRIPTION OF PREFERRED EMBODIMENTS

The present invention will now be described more fully hereinafter with reference to the accompanying drawings, in which a preferred embodiment of the invention is shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

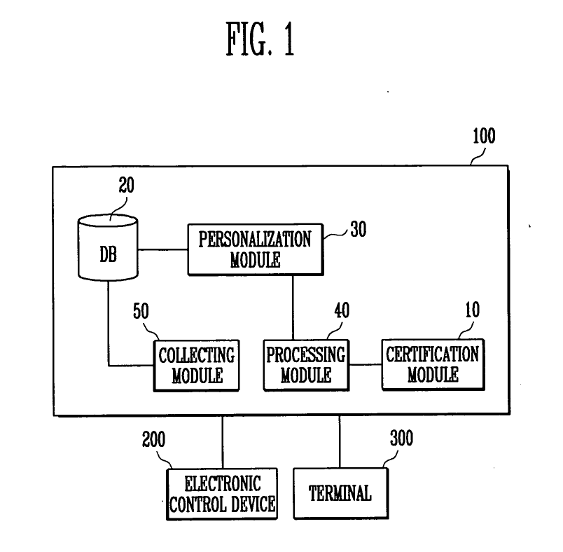

FIG. 1 is a block diagram of telematics equipment having preference extraction function in accordance with the present invention.

The telematics equipment 100 in accordance with the present invention is connected to various devices of a vehicle to receive information from the exterior through a network. The various devices include: electronic control devices 200, installed in the vehicle, such as an electronic control unit (ECU), a speedometer, a wiper, a seat adjustment device, a mirror adjustment device, an audio device, an air conditioner, a door opening/closing device, various sensors and so on; and personal handheld terminals 300 such as a navigation system, a personal digital assistant (PDA), a mobile phone, a notebook computer and so on.

The telematics equipment 100 is connected to the electronic control devices 200 of the vehicle to control operations of the devices, and functions as general telematics equipment for connecting the terminals 300 to an external server or communication device through the network.

In addition, the telematics equipment 100 further includes a certification module 10, a database 20, a personalization module 30, a processing module 40, and a collecting module 50. The certification module 10 receives personal information from the driver of the vehicle to provide use authority of the vehicle, and the collecting module 50 collects propensity and pattern information whenever the driver uses the various devices. The database 20 stores the propensity and pattern information collected by the collecting module 50. The personalization module 30 analyzes the stored information to extract preference information of the driver, and the processing module 40 receives the extracted preference information from the personalization module 30 to generate control signals for setting the various devices of the vehicle. As the control signals are transmitted to the various devices, the various devices are set as an optimal state to the driver, without any direct action by the driver.

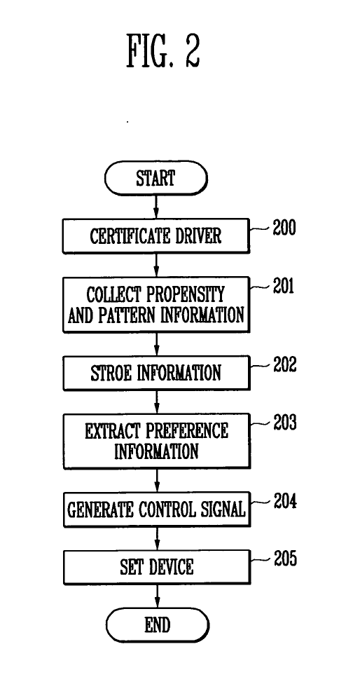

Hereinafter, operations of the telematics as described above will be described with reference to FIG. 2.

First, the driver on the vehicle operates a key box to start the engine, power is supplied to the telematics equipment 100, and the certification module 10 operates to require the driver to input personal information such as identification/password, iris, fingerprint, mobile phone, face and so on, through a monitor or input device. The certification module 10 identifies the driver through the input personal information to allow use of the telematics equipment 100 when the personal information is equal to pre-registered information (Step 200).

Then, the driver uses the various devices of the vehicle during driving. Here, the collecting module 50 collects the propensity and pattern information whenever the driver uses the various devices (Step 201), and stores the collected propensity and pattern information in the database 20 (Step 202). At this time, the information of the telematics equipment 100 may be supplied from an application programming interface (API) provided by middleware of the terminal, and the information of the electronic control device may be collected from a device for converting electrical signals to data.

The collecting module 50 selectively collects required information according to rules designated to a configuration file, and converts the collected information to a data format to store the data in the database 20 together with time information. In order to designate information to be collected to the configuration file, the collecting module 50 may collect the designated information in time intervals after designating a kind of information and time intervals, or may designate information and time whenever the designated kind of information is changed. In consideration of network cost and capacity of data to be stored, the latter is preferable. At this time, the collected information may be transmitted to a remote center in uniform intervals to be analyzed according to a predetermined rule to generate statistics. The rule is applied depending on the kind of information. For example, in the case of a temperature, a factor about a season or an external temperature of a corresponding date is applied.

The propensity information may include traveling speed, a traveling path, an adjustment position (level) of the seat adjustment device, a volume level of the audio device, operating speed of the wiper, temperature and wind intensity of the air conditioner, software (menu) setting, and so on as information for determining a preference action of the driver. The pattern information is as information for analyzing a preference action of the driver according to time, for example, may be a date, a day of the week, and time when the various devices are used.

For example, the following information might be collected: a driver 1 operates the audio device with a channel 1 and a volume level 4 from 8 am to 9 am, Monday to Friday, and the air conditioner at a temperature of 25° C. and wind intensity of a level 2; and a driver 2 operates the seat adjustment device with a level 3 from 9 am to 9:30 am Sunday, and the navigation system from home (origin) to church (destination). If this information is collected, information such as the audio channel and volume setting, the temperature and wind intensity of the air conditioner, and the operation of the navigation system is stored as the propensity information, and the information such as the day from Monday to Friday, the time of 8 am to 9 am, etc. is stored as the pattern information.

As described above, the collecting module 50 collects the propensity and pattern information and stores the collected information in the database 20 according to categories.

The personalization module 30 may analyze the propensity and pattern information stored in the database 20 to extract the preference information of the driver, or transmit the collected information to the remote center in uniform intervals to analyze the collected information in order to extract the preference information (Step 203). The information analysis method may employ a method of extracting the information by similar items repeated through a mining technique, and the operation rule is changed as follows according to the extracted information.

Ex) Automatic defrost, and automatic defog

Where C is an external temperature, R is a rainfall, and T is a temperature predetermined in the vehicle, when the driver operates the defrosting or devaporizing apparatus, C, R and T may be repeated similar items extracted by the mining technique, and their operation rules are as Table 1.

TABLE 1

If ( ( Ccon == Ccur ) && ( Rcon == Rcur ) )

while ( Tcur ! = Tcon )

operate eliminating function

| | |
|---|---|
| Ccur = current temperature | Ccon = conditional temperature |
| Rcur = current rainfall | Rcon = conditional rainfall |

Tcur = current temperature in vehicle
Tcon = conditional temperature in vehicle

The preference information may be set such that it can be extracted periodically or non-periodically according to the predetermined rule (algorithm).

For example, the propensity and pattern information stored for a certain period is analyzed to extract the preference information of the driver, for example, a seat position (level), an audio volume level, an air conditioner level, a display image of the terminal 300, and so on within the predetermined time. The rules for extracting the preference information may be an extraction algorithm having threshold weight such as the number of uses, priority order (the first, the latest, and so on), probability, and so on. At this time, the preference information is extracted on the basis of the predetermined rule, but the information may be extracted only when a used rate of a central processing unit (CPU) is less than a predetermined value (%). The predetermined value is set to allow an idle value (%) to be left to some extent on the basis of the result of benchmarking the analysis and extraction operations. For example, the used rate of the CPU used in the analysis and extraction operations+the minimum used rate of the terminal during driving+20%=100%. The idle value (%) is set by a test.

The preference information extracted by the personalization module 30 is transmitted to the processing module 40, and the processing module 40 generates control signals for setting the various devices of the vehicle according to the preference information (Step 204). The control signals are transmitted to the various devices so that the various devices are set as the optimal state to the driver (Step 205).

The personalization module 30 extracts the preference information periodically and non-periodically, however, the preference information may be extracted only when the telematics equipment 100 is first operated or the driver wants it. In addition, the personalization module 30 may delete or arrange the stored information periodically or non-periodically in order to effectively operate the database 20.

As can be seen from the foregoing, the telematics equipment having a preference extraction function in accordance with the present invention is capable of setting the various devices of the vehicle to an optimal state to the driver by collecting the propensity and pattern information when the driver uses the various devices and information of the vehicle, and extracting the preference information on the basis of the collected information to apply the preference information to the various devices, without a direct action of the driver, thereby providing safety and optimal convenience to the driver.

Although the present invention has been described with reference to a certain exemplary embodiment thereof, it will be understood by those skilled in the art that a variety of modifications and variations may be made to the present invention without departing from the spirit or scope of the present invention defined in the appended claims, and their equivalents.

What is claimed is:

1. Telematics equipment connected to various devices of a vehicle, and configured to receive information from the exterior through a network, the telematics equipment comprising:
a collecting module for collecting propensity and pattern information when a driver uses the various devices of the vehicle;
a personalization module for analyzing the collected propensity and pattern information and extracting preference information of the driver; and
a processing module for receiving the preference information from the personalization module and generating signals for controlling the various devices.

2. The telematics equipment according to claim 1, wherein the various devices comprise electronic control devices which are installed in the vehicle and personal handheld terminals.

3. The telematics equipment according to claim 1, wherein the preference information is information for determining a preference action of the driver, and the pattern information is information for analyzing the preference action according to time.

4. The telematics equipment according to claim 1, wherein the personalization module extracts the preference information periodically or non-periodically according to a predetermined rule.

5. The telematics equipment according to claim 4, wherein the rule is an extraction algorithm according to at least one of the number of uses, priority order, and probability.

6. The telematics equipment according to claim 1, wherein the personalization module extracts the preference information when the telematics equipment is initially operated.

7. The telematics equipment according to claim 1, further comprising:
a certification module for receiving personal information from the driver of the vehicle to provide use authority; and
a database for storing the collected propensity and pattern information.

8. The telematics equipment according to claim 7, wherein the personalization module deletes and arranges the information stored in the database periodically and non-periodically to effectively operate the database.
